(19) United States
(12) Patent Application Publication
(10) Pub. No.: US 2017/0352319 A1
(43) Pub. Date: Dec. 7, 2017

(54) PIXEL CIRCUIT AND OPERATING METHOD OF PIXEL CIRCUIT

(71) Applicant: AU OPTRONICS CORPORATION, Hsin-chu (TW)

(72) Inventors: Tokuro OZAWA, Hsin-chu (TW); Koji AOKI, Hsin-chu (TW); Chia-Che HUNG, Hsin-chu (TW); Chia-Wei KUO, Hsin-chu (TW); Chia-Ting HSIEH, Hsin-chu (TW); Bo-Shiang TZENG, Hsin-chu (TW)

(21) Appl. No.: 15/592,719

(22) Filed: May 11, 2017

(30) Foreign Application Priority Data
Jun. 4, 2016 (TW) 105117752

(51) Int. Cl. G09G 3/36

(52) U.S. Cl. CPC G09G 3/3648; G09G 3/3688; G09G 3/3677; G09G 2300/0465; G09G 2310/061; G09G 2330/021; G09G 2310/0251

(57) ABSTRACT

A pixel circuit includes a display unit, a driving unit, a reset unit, a data unit, and a storage unit. The display unit is electrically coupled to a first supply voltage source. The driving unit has one end electrically coupled to the display unit and has another end electrically coupled to a second supply voltage source. The driving unit charges the display unit. The reset unit is electrically coupled to the driving unit and the display unit, and provides a reset voltage to an operating node between the driving unit and the display unit. The data unit is electrically coupled to the driving unit and provides a data voltage to the driving unit. The storage unit stores a voltage difference between the operating node and a data node between the data unit and the driving unit.

### CROSS-REFERENCE TO RELATED PATENT APPLICATION

This application claims the benefit of priority under 35 U.S.C. §119(a) to Taiwan Patent Application No. 105117752, filed in Taiwan, R.O.C. on Jun. 4, 2016. The entire content of the above identified application is incorporated herein by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD

The present disclosure relates to circuits and an operating method of circuits, and more particularly, to pixel circuits and an operating method of pixel circuits.

### BACKGROUND

With the development of science and technology, display apparatuses have been widely applied in life of people.

Generally, a liquid crystal display apparatus may include a gate drive circuitry, a source drive circuitry, and a pixel circuit matrix. A pixel circuit includes a driving transistor, a switching transistor, a pixel capacitor, and a liquid crystal element. The gate drive circuitry may generate a plurality of scanning signals in sequence, and provide these scanning signals to a scanning line, to enable switching transistors of pixel circuits row by row. The source drive circuitry may generate a plurality of data signals, and provide these data signals to driving transistors by using the enabled switching transistors, so that the driving transistors charge pixel capacitors according to the data signals, to control liquid crystal elements, and thus that operation achieves an effect of controlling the light passing through the liquid crystal elements. In this way, the liquid crystal display apparatus can display an image.

During application of some different liquid crystal elements (for example, a blue-phase liquid crystal display apparatus), a data signal needs to have a relatively high voltage level (for example, 35 V), which causes difficulties in operation. Moreover, the number of transistors in the pixel circuit needs to be increased, in order to control the liquid crystal elements. That correspondingly reduces the aperture ratio of the liquid crystal display apparatus, and downgrades the display quality.

### SUMMARY

An implementation aspect of certain embodiments relates to a pixel circuit. According to an embodiment, the pixel circuit includes: a display unit, a driving transistor, a reset transistor, a data transistor, and a storage capacitor. The display unit is electrically coupled to a first supply voltage source, where the display unit includes a display element. The driving transistor has a first end, a second end, and a gate terminal, where the first end of the driving transistor is electrically coupled to the display unit, and the second end of the driving transistor is electrically coupled to a second supply voltage source. The reset transistor has one end electrically coupled to the first end of the driving transistor and another end electrically coupled to a reset voltage source. The data transistor has one end electrically coupled to the gate terminal of the driving transistor and another end electrically coupled to a data voltage source. The storage capacitor has one end electrically coupled to the first end of the driving transistor and another end electrically coupled to the gate terminal of the driving transistor.

Another implementation aspect of certain embodiments relates to a pixel circuit. According to an embodiment, the pixel circuit includes: a display unit, a driving unit, a reset unit, a data unit, and a storage unit. The display unit is electrically coupled to a first supply voltage source, where the display unit includes a display element. The driving unit has one end electrically coupled to the display unit and another end electrically coupled to a second supply voltage source, and is configured to charge the display unit. The reset unit is electrically coupled to the driving unit and the display unit, and configured to provide a reset voltage to an operating node between the driving unit and the display unit. The data unit is electrically coupled to the driving unit, and configured to provide a data voltage to the driving unit. The storage unit has one end electrically coupled to the data unit and another end electrically coupled to the display unit, and is configured to store a voltage difference between the operating node and a data node between the data unit and the driving unit.

Another implementation aspect of certain embodiments relates to an operating method of a pixel circuit. According to an embodiment, the pixel circuit includes a display unit, a driving transistor, and a storage capacitor, the display unit is electrically coupled to a first end of the driving transistor, one end of the storage capacitor is electrically coupled to the first end of the driving transistor, and another end of the storage capacitor is electrically coupled to a gate terminal. The operating method includes: providing a reset voltage to the first end of the driving transistor, and providing a preset voltage to the gate terminal of the driving transistor; conducting a second supply voltage source and a second end of the driving transistor, and stopping providing the reset voltage to the first end of the driving transistor, so that the driving transistor receives a compensation current, to charge the display unit, and a cross voltage on two ends of the storage capacitor gradually approaches a threshold voltage of the driving transistor; providing a data voltage to the gate terminal of the driving transistor, and conducting the second supply voltage source and the second end of the driving transistor, so that the driving transistor receives a driving current in response to the data voltage, to charge the display unit, until the cross voltage on the two ends of the storage capacitor is a set voltage; stopping providing the data voltage to the gate terminal of the driving transistor, and providing the reset voltage to the first end of the driving transistor; and stopping providing the reset voltage to the first end of the driving transistor, and conducting the second supply voltage source and the second end of the driving transistor, so that the driving transistor receives a charging current in response to the set voltage, to charge the display unit.

Another implementation aspect of certain embodiments relates to an operating method of a pixel circuit. According to an embodiment, the pixel circuit includes a display unit, a driving transistor, and a storage capacitor, the display unit is electrically coupled to a first end of the driving transistor, one end of the storage capacitor is electrically coupled to the first end of the driving transistor, and another end of the storage capacitor is electrically coupled to a gate terminal. The operating method includes: providing a control voltage to the gate terminal of the driving transistor, and providing a reset voltage to the first end of the driving transistor, so that the driving transistor switches on the control voltage in response to the reset voltage; providing the control voltage to the gate terminal of the driving transistor, and stopping providing the reset voltage to the first end of the driving transistor, so that the driving transistor receives a compensation current, to charge the display unit, until a cross voltage on two ends of the storage capacitor is a threshold voltage of the driving transistor; stopping providing the control voltage to the gate terminal of the driving transistor, and providing a data voltage to the gate terminal of the driving transistor, so that the driving transistor receives a driving current in response to the data voltage, to charge the display unit, until the cross voltage on the two ends of the storage capacitor is a set voltage; stopping providing the control voltage to the gate terminal of the driving transistor, stopping providing the data voltage to the gate terminal of the driving transistor, and providing the reset voltage to the first end of the driving transistor; and stopping providing the control voltage to the gate terminal of the driving transistor, stopping providing the data voltage to the gate terminal of the driving transistor, and stopping providing the reset voltage to the first end of the driving transistor, so that the driving transistor receives a charging current in response to the set voltage, to charge the display unit.

A pixel circuit can be implemented by applying an embodiment above. By means of this pixel circuit, charging of a display capacitor can be controlled by using a data signal at a relatively low voltage level.

### BRIEF DESCRIPTION OF THE DRAWINGS

The disclosure will become more fully understood from the detailed description given herein below for illustration only, and thus are not limitative of the disclosure, and wherein:

FIG. 1 is a schematic diagram of a pixel circuit according to an embodiment;

FIG. 2 is a schematic diagram of a pixel circuit according to an embodiment;

FIG. 3 is a schematic diagram of signals of a pixel circuit according to an embodiment;

FIG. 4 is a schematic diagram of an operation state of a pixel circuit according to an embodiment;

FIG. 5 is a schematic diagram of another operation state of a pixel circuit according to an embodiment;

FIG. 6 is a schematic diagram of another operation state of a pixel circuit according to an embodiment;

FIG. 7 is a schematic diagram of another operation state of a pixel circuit according to an embodiment;

FIG. 8 is a schematic diagram of another operation state of a pixel circuit according to an embodiment;

FIG. 9 is a schematic diagram of another operation state of a pixel circuit according to an embodiment;

FIG. 10 is a schematic diagram of another operation state of a pixel circuit according to an embodiment;

FIG. 11 is a schematic diagram of charging a display capacitor at different data voltages in a pixel circuit according to an embodiment;

FIG. 12 is a schematic diagram of charging a display capacitor at different data voltages in a pixel circuit according to an embodiment;

FIG. 13 is a schematic diagram of currents of driving transistors having different carrier drift rates according to an embodiment;

FIG. 14 is a schematic diagram of a display apparatus according to an embodiment;

FIG. 15 is a schematic diagram of signals of a display apparatus according to an embodiment;

FIG. 16 is a schematic diagram of a pixel circuit according to an embodiment;

FIG. 17 is a schematic diagram of a pixel circuit according to an embodiment;

FIG. 18 is a schematic diagram of signals of a pixel circuit according to an embodiment;

FIG. 19 is a schematic diagram of an operation state of a pixel circuit according to an embodiment;

FIG. 20 is a schematic diagram of another operation state of a pixel circuit according to an embodiment;

FIG. 21 is a schematic diagram of another operation state of a pixel circuit according to an embodiment;

FIG. 22 is a schematic diagram of another operation state of a pixel circuit according to an embodiment;

FIG. 23 is a schematic diagram of another operation state of a pixel circuit according to an embodiment;

FIG. 24 is a schematic diagram of another operation state of a pixel circuit according to an embodiment;

FIG. 25 is a schematic diagram of another operation state of a pixel circuit according to an embodiment;

FIG. 26 is a schematic diagram of a display apparatus according to an embodiment;

FIG. 27 is a schematic diagram of signals of a display apparatus according to an embodiment;

FIG. 28 is a flowchart of an operating method of a pixel circuit according to an embodiment;

FIG. 29 is a flowchart of an operating method of a pixel circuit according to an embodiment;

FIG. 30A to FIG. 30C are schematic diagrams of a pixel circuit according to an embodiment; and

FIG. 31 is a simplified circuit diagram of a pixel circuit according to an embodiment.

### DETAILED DESCRIPTION

The following clearly describes the spirit of the disclosure by using accompanying drawings and detailed descriptions. After learning embodiments of the disclosure, a person of ordinary skill in the art can make changes and modifications to the technologies demonstrated in the disclosure without departing from the spirit and scope of the disclosure.

The terms “first”, “second”, and other similar terms used in this specification do not particularly indicate a sequence or an order, and are not intended to limit the interpretations, but only to distinguish between elements or operations described by using same technical words.

The term “electrically coupled” used in this specification may mean that two or more elements are in direct physical or electrical contact or indirect physical or electrical contact. It is dependent on the content of the embodiments.

The terms “comprise”, “include”, “have”, “contain”, and the similar used in this specification are all open ended term, that is, the terms do not preclude unlisted elements.

The term “and/or” used in this specification indicates any one or combination of juxtaposed selections.

The directional terms used in this specification such as “on”, “under”, “left”, “right”, “front”, and “back” indicate only the directions of the accompanying drawings. Therefore, the used directional terms are intended to illustrate rather than limit the present disclosure.

The terms used in this specification generally have the plain meaning of each term used in the related art unless specifically noted. Some terms used to describe the disclosure will be discussed below or elsewhere in this specification, so as to provide additional guidance to persons skilled in the art in addition to the description of the disclosure.

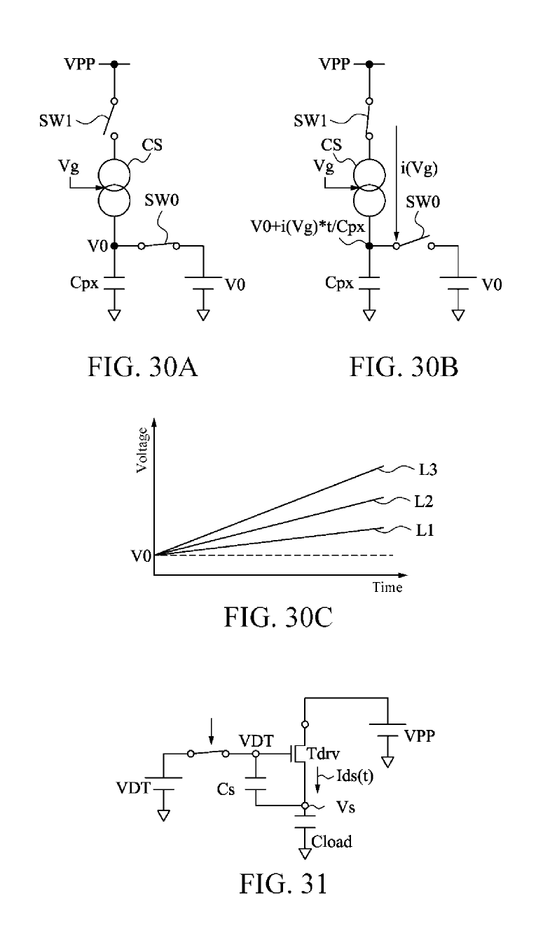

Referring to FIG. 30A, in an initial state, a voltage source having a voltage V0 charges a capacitor Cpx to the voltage V0 by using a switch SW0 that is switched on. Next, referring to FIG. 30B, a current source CS corresponding to a voltage Vg obtains, by using a switch SW1 that is switched on, a current i(Vg) from a voltage source having a voltage VPP, and charges the capacitor Cpx for t seconds by using the current i(Vg). At this time, the switch SW0 is cut off. A voltage on the capacitor Cpx may be expressed by V0+i(Vg)*t/Cpx. Referring to FIG. 30C, the lines L1 to L3 respectively represent relations between charging time and voltages on the capacitor Cpx at different voltages Vg (that is, voltages Vg1 to Vg3). By means of this conception, the following certain embodiments can be implemented.

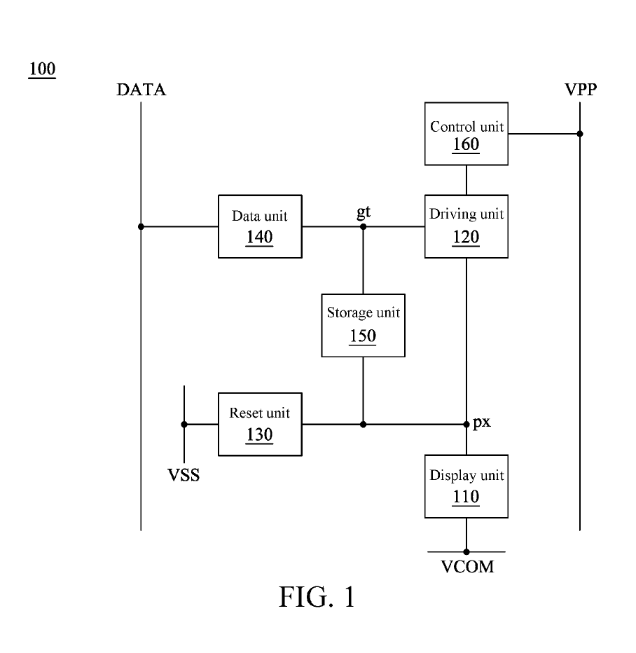

FIG. 1 is a schematic diagram of a pixel circuit 100 according to an embodiment. In this embodiment, the pixel circuit 100 includes: a display unit 110, a driving unit 120, a reset unit 130, a data unit 140, and a storage unit 150. The display unit 110 is electrically coupled to the supply voltage source having a supply voltage VCOM. The driving unit 120 has one end electrically coupled to the display unit 110 and another end electrically coupled to the supply voltage source having a supply voltage VPP, and is configured to charge the display unit 110. The reset unit 130 is electrically coupled to the driving unit 120 and the display unit 110, and configured to provide a reset voltage VSS to an operating node px between the driving unit 120 and the display unit 110. The data unit 140 is electrically coupled to the driving unit 120, and configured to provide a data voltage VDT on the data line DATA to the driving unit 120 and the storage unit 150. The storage unit 150 has one end electrically coupled to the data unit 140 and another end electrically coupled to the display unit 110, and is configured to store a voltage difference between the data node gt and the operating node px between the data unit 140 and the driving unit 120.

In a certain embodiment, the pixel circuit 100 further includes a control unit 160. The control unit 160 has one end electrically coupled to the driving unit 120 and another end electrically coupled to the supply voltage source having the supply voltage VPP, and is configured to switch on or switch off the conductive path between the driving unit 120 and the supply voltage source having the supply voltage VPP.

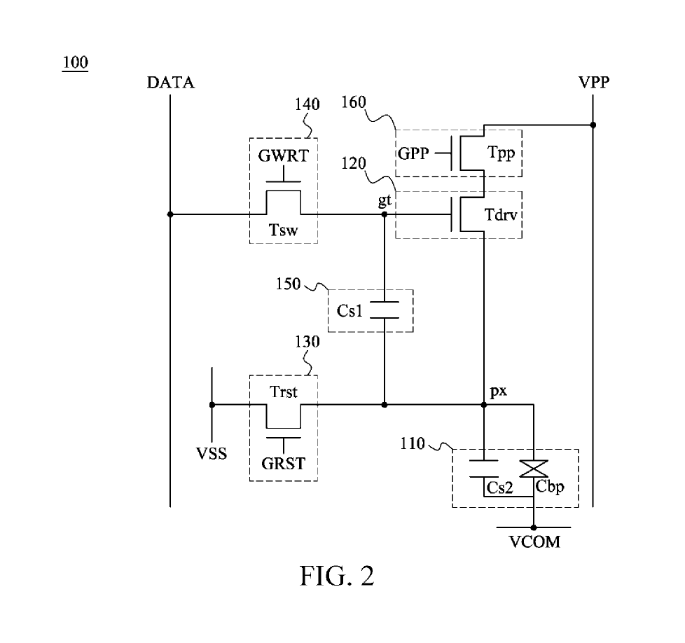

Referring to FIG. 2, in a certain embodiment, the display unit 110 includes a display element Cbp and a display capacitor Cs2. In an embodiment, the display element Cbp may be a liquid crystal sandwiched between two electrodes. The driving unit 120 includes a driving transistor Tdrv. The reset unit 130 includes a reset transistor Trst. The data unit 140 includes a data transistor Tsw. The storage unit 150 includes a storage capacitor Cs1. The control unit 160 includes a control transistor Tpp.

In this embodiment, the display element Cbp and the display capacitor Cs2 are connected in parallel. The display element Cbp and the display capacitor Cs2 each has one end electrically coupled to the driving transistor Tdrv. The display element Cbp and the display capacitor Cs2 each has another end coupled to the supply voltage source having the supply voltage VCOM.

The driving transistor Tdry has a first end, a second end, and a gate terminal. The first end of the driving transistor Tdry is electrically coupled to the display unit 110, the second end of the driving transistor Tdry is electrically coupled to the supply voltage source having the supply voltage VPP, directly or through another transistor, and the gate terminal of the driving transistor Tdry is electrically coupled to the data node gt.

The reset transistor Trst has a first end, a second end, and a gate terminal. The first end of the reset transistor Trst is electrically coupled to the first end of the driving transistor Tdrv, the second end of the reset transistor Trst is electrically coupled to a reset voltage source having the reset voltage VSS, and the gate terminal of the reset transistor Trst is configured to receive a reset signal GRST.

The data transistor Tsw has a first end, a second end, and a gate terminal. The first end of the data transistor Tsw is electrically coupled to the gate terminal of the driving transistor Tdrv, the second end of the data transistor Tsw is electrically coupled to the data line DATA, and the gate terminal of the data transistor Tsw is configured to receive a writing signal GWRT.

One end of the storage capacitor Cs1 is electrically coupled to the first end of the driving transistor Tdrv, and another end of the storage capacitor Cs1 is electrically coupled to the gate terminal of the driving transistor Tdrv.

The control transistor Tpp has a first end, a second end, and a gate terminal. The first end of the control transistor Tpp is electrically coupled to the second end of the driving transistor Tdrv, and the second end of control transistor Tpp is electrically coupled to the supply voltage source having the supply voltage VPP.

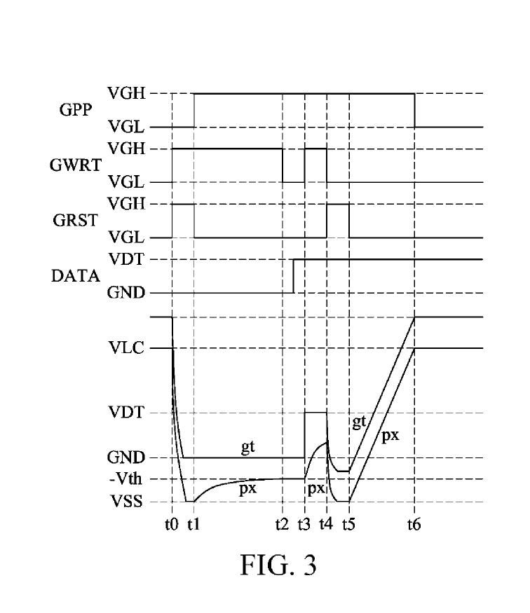

The following describes operations of the pixel circuit 100 in an embodiment with reference to FIG. 3 to FIG. 10.

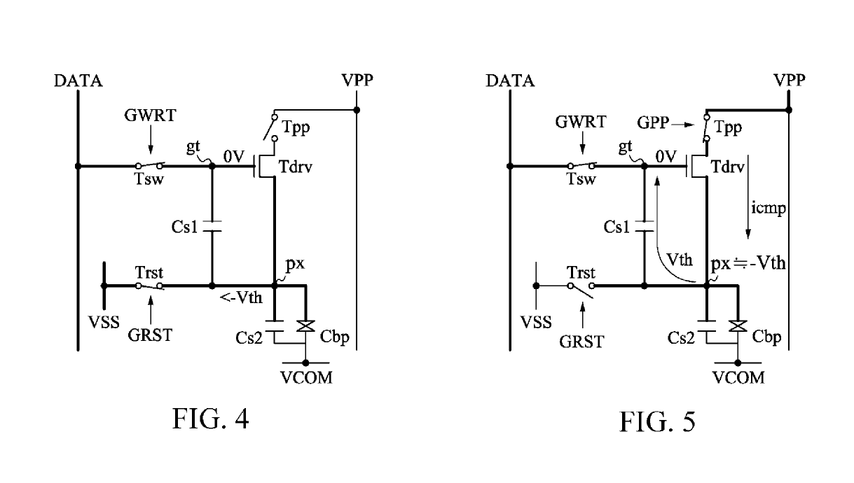

Referring to FIG. 3 and FIG. 4, between time points t0 and t1, the reset transistor Trst of the reset unit 130 is configured to be switched on, in response to a reset signal GRST having a high voltage level VGH, to provide the reset voltage VSS to the node px. The data transistor Tsw of the data unit 140 is configured to be switched on, in response to a writing signal GWRT having the high voltage level VGH, to provide the node gt a preset voltage having a voltage level GND (for example, 0 V) on the data line DATA. The control transistor Tpp is switched off in response to a control signal GPP having a low voltage level VGL. The driving transistor Tdry in the driving unit 120 is configured to be switched on in response to the preset voltage having the voltage level GND on the gate terminal of the driving transistor Tdry and the reset voltage VSS on the first end of the driving transistor Tdrv, where a voltage difference between the preset voltage and the reset voltage VSS is greater than a threshold voltage Vth of the driving transistor Tdry (for example, a voltage on the node gt is less than −Vth).

Referring to FIG. 3 and FIG. 5, between time points t1 and t2, the reset transistor Trst of the reset unit 130 is configured to be switched off, in response to a reset signal GRST having the low voltage level VGL, in order to stop providing the reset voltage VSS to the node px. The data transistor Tsw of the data unit 140 is configured to keep being switched on, in response to the writing signal GWRT having the high voltage level VGH, to provide the node gt the preset voltage having the voltage level GND. The control transistor Tpp of the control unit 160 is configured to be switched on, in response to a control signal GPP having the high voltage level VGH, to conduct the supply voltage source having the supply voltage VPP and the driving unit 120. The driving transistor Tdry in the driving unit 120 is configured to be switched on, in response to the preset voltage having the voltage level GND on the gate terminal of the driving transistor Tdry (that is, the node gt) and the voltage on the first end of the driving transistor Tdry (that is, the node px), to receive a compensation current icmp from the supply voltage source having the supply voltage VPP and then to charge the node px, so that a voltage difference between the node gt and the node px gradually approaches the threshold voltage Vth of the driving transistor Tdrv, until the voltage difference between the node gt and the node px is substantially equal to the threshold voltage Vth of the driving transistor Tdrv. At this time, the voltage on the node px is approximately equal to −Vth. In this way, a voltage applied on the storage capacitor Cs1 can be equal to the threshold voltage Vth of the driving transistor Tdrv.

Next, between time points t2 and t3, the reset transistor Trst of the reset unit 130 is configured to be switched off in response to the reset signal GRST having the low voltage level VGL, the control transistor Tpp of the control unit 160 is configured to be switched on in response to the control signal GPP having the high voltage level VGH, and the data transistor Tsw of the data unit 140 is configured to be switched off in response to a writing signal GWRT having the low voltage level VGL. At this time, the data line DATA is switched from providing the preset voltage having the voltage level GND (for example, 0 V) to providing the data voltage VDT.

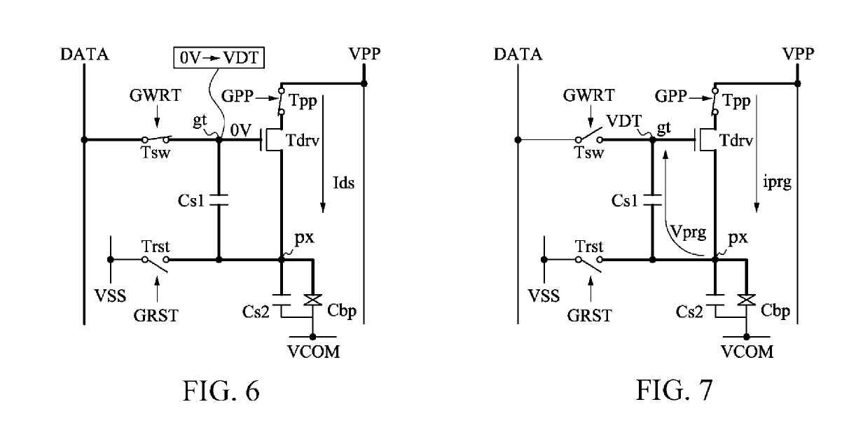

Referring to FIG. 3 and FIG. 6, between time points t3 and t4, the reset transistor Trst of the reset unit 130 is configured to be switched off in response to the reset signal GRST having the low voltage level VGL. The control transistor Tpp of the control unit 160 is configured to be switched on in response to the control signal GPP having the high voltage level VGH, to keep conducting the supply voltage source having the supply voltage VPP and the driving unit 120. The data transistor Tsw of the data unit 140 is configured to be switched on, in response to the writing signal GWRT having the high voltage level VGH, to provide the data voltage VDT to the node gt. The driving transistor Tdry in the driving unit 120 is configured to obtain a charging current Ids from the supply voltage source having the supply voltage VPP, in response to the data voltage VDT, to charge the node px, so that a voltage level of the node px increases from −Vth. As the voltage level of the node px increases, the voltage difference between the node px and node gt decreases, so that the charging current Ids also decreases.

Referring to FIG. 3 and FIG. 7, at the time point t4, the reset transistor Trst of the reset unit 130 is configured to be switched off in response to the reset signal GRST having the low voltage level VGL. The control transistor Tpp of the control unit 160 is configured to be switched on, in response to the control signal GPP having the high voltage level VGH, to keep conducting the supply voltage source having the supply voltage VPP and the driving unit 120. The data transistor Tsw of the data unit 140 is configured to be switched off, in response to the writing signal GWRT having the low voltage level VGL, to stop providing the data voltage VDT to the node gt. At this time, a voltage difference Vprg exists between the node px and the node gt, and the driving transistor Tdry in the driving unit 120 obtains a fixed current iprg from the supply voltage source having the supply voltage VPP, in response to the voltage difference Vprg between the node px and the node gt, to charge the node px.

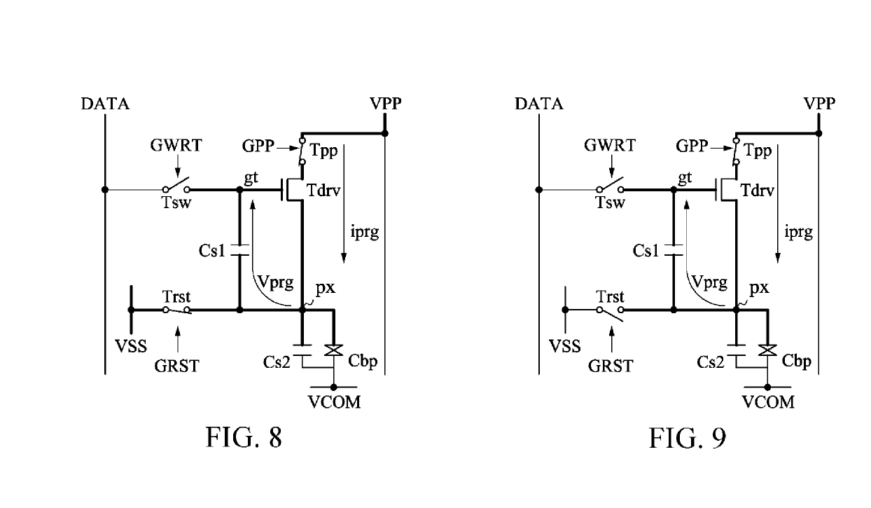

Referring to FIG. 3 and FIG. 8, between time points t4 and t5, the control transistor Tpp of the control unit 160 is configured to be switched on, in response to the control signal GPP having the high voltage level VGH, to keep conducting the supply voltage source having the supply voltage VPP and the driving unit 120. The data transistor Tsw of the data unit 140 is configured to be switched off in response to the writing signal GWRT having the low voltage level VGL. The reset transistor Trst of the reset unit 130 is configured to be switched on, in response to the reset signal GRST having the high voltage level VGH, to provide the reset voltage VSS to the node px and to simultaneously decrease voltages of the node px and the node gt. At this time, the voltage difference Vprg exists between the node px and the node gt, and the driving transistor Tdry in the driving unit 120 obtains the fixed current iprg from the supply voltage source having the supply voltage VPP in response to the voltage difference Vprg between the node px and the node gt.

Referring to FIG. 3 and FIG. 9, between time points t5 and t6, the control transistor Tpp of the control unit 160 is configured to be switched on in response to the control signal GPP having the high voltage level VGH, to keep conducting the supply voltage source having the supply voltage VPP and the driving unit 120. The data transistor Tsw of the data unit 140 is configured to be switched off in response to the writing signal GWRT having the low voltage level VGL. The reset transistor Trst of the reset unit 130 is configured to be switched off, in response to the reset signal GRST having the low voltage level VGL, to stop providing the reset voltage VSS to the node px. At this time, the voltage difference Vprg exists between the node px and the node gt. The driving transistor Tdry in the driving unit 120 obtains the fixed current iprg from the supply voltage source having the supply voltage VPP, in response to the voltage difference Vprg between the node px and the node gt, to charge the node px, to simultaneously increase the voltages of the node px and the node gt.

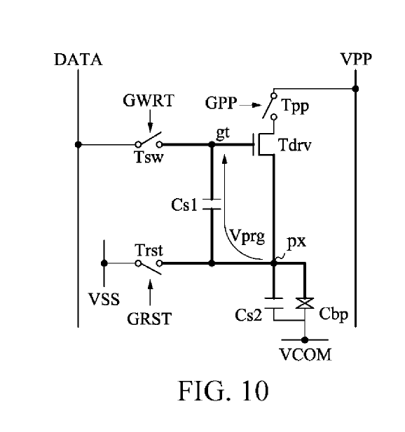

Referring to FIG. 3 and FIG. 10, after the time point t6, the control transistor Tpp of the control unit 160 is configured to be switched off in response to the control signal GPP having the low voltage level VGL, to separate the supply voltage source having the supply voltage VPP and the driving unit 120. The data transistor Tsw of the data unit 140 is configured to be switched off in response to the writing signal GWRT having the low voltage level VGL. The reset transistor Trst of the reset unit 130 is configured to be switched off in response to the reset signal GRST having the low voltage level VGL. At this time, the driving transistor Tdry in the driving unit 120 is configured to stop charging the node px. A voltage applied on two ends of the display capacitor Cs2 is kept at a fixed level, to charge the display element Cbp.

By means of the foregoing settings, the pixel circuit 100 can be implemented by using four transistors and thus can reduce the influence on an aperture ratio of a display apparatus.

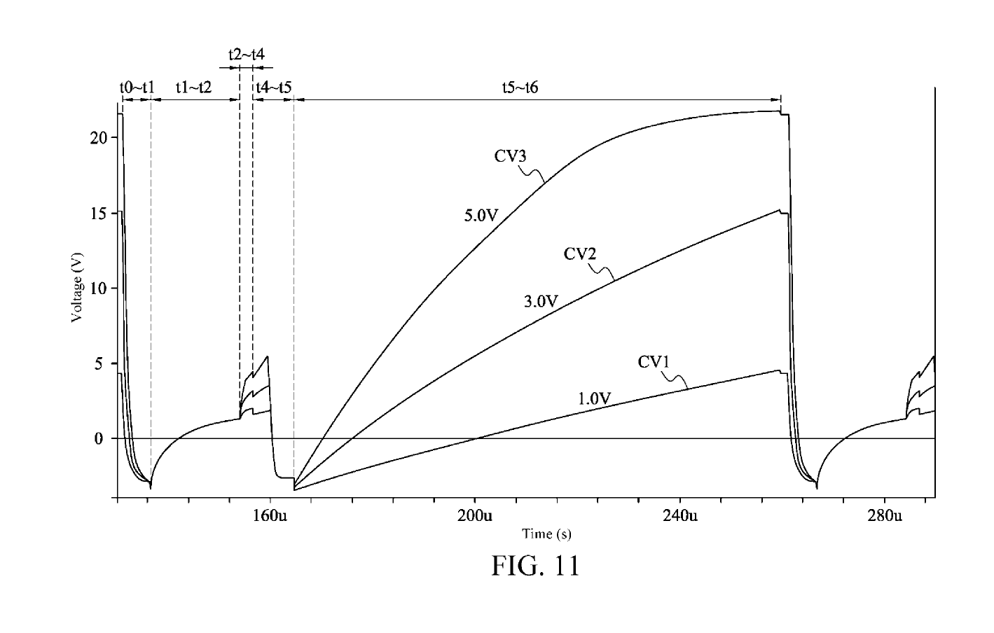

In addition, as shown in FIG. 11, by means of the foregoing operations, when the supply voltage VPP is 22 V and the high voltage level VGH is 25 V, a data voltage VDT not greater than 5 V may be used to charge the display capacitor Cs2 to approximately 22 V, wherein the vertical axis of FIG. 11 represents a voltage stored in the display capacitor Cs2, and the horizontal axis FIG. 11 represents time. For example, the curve CV1 represents a relation between a voltage stored in the display capacitor Cs2 and time when the data voltage VDT is 1 V, the curve CV2 represents a relation between a voltage stored in the display capacitor Cs2 and time when the data voltage VDT is 3 V, and the curve CV3 represents a relation between a voltage stored in the display capacitor Cs2 and time when the data voltage VDT is 5 V.

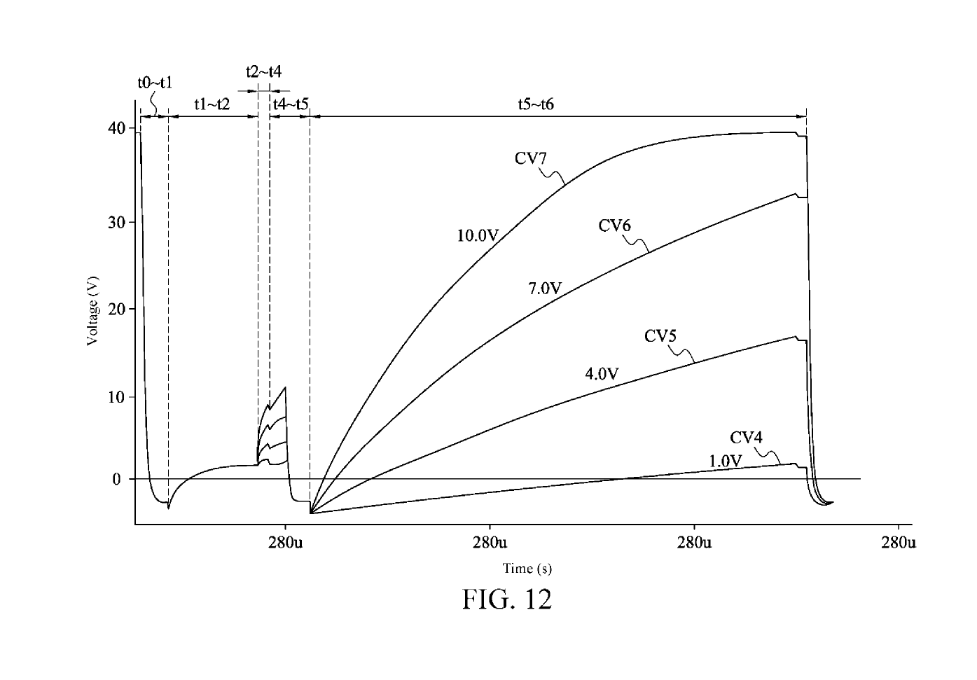

Further, as shown in FIG. 12, by means of the foregoing operations, when the supply voltage VPP is 40 V and the high voltage level VGH is 43 V, a data voltage VDT not greater than 10 V may be used to charge the display capacitor Cs2 to approximately 40 V, wherein the vertical axis of FIG. 12 represents a voltage stored in the display capacitor Cs2, and the horizontal axis of FIG. 12 represents time. For example, the curve CV4 represents a relation between a voltage stored in the display capacitor Cs2 and time when the data voltage VDT is 1 V, the curve CV5 represents a relation between a voltage stored in the display capacitor Cs2 and time when the data voltage VDT is 4 V, the curve CV6 represents a relation between a voltage stored in the display capacitor Cs2 and time when the data voltage VDT is 7 V, and the curve CV7 represents a relation between a voltage stored in the display capacitor Cs2 and time when the data voltage VDT is 10 V. Moreover, in the foregoing operations, the time point t4 may be controlled to compensate the current iprg, so that driving transistors Tdry having different carrier drift rates all can obtain a same current iprg at the time point t4. The following is the specific description.

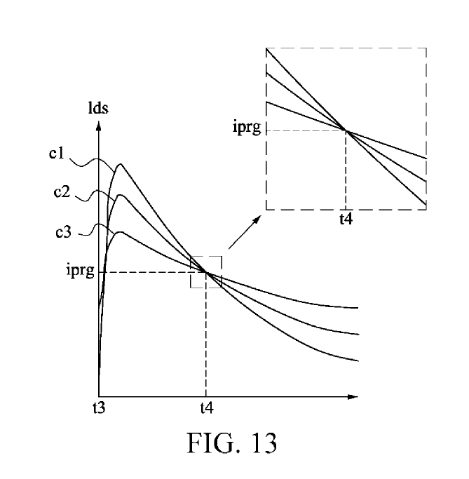

Referring to FIG. 13, the curves c1 to c3 respectively represent currents obtained by the driving transistors Tdry having different carrier drift rates. The curves c1 to c3 intersects at an intersection. Therefore, if the time point t4 is set to time corresponding to the intersection, the driving transistors Tdry having different carrier drift rates all can obtain a same current iprg at the time point t4. That is, if an appropriate time point t4 can be set, regardless of what carrier drift rates of driving transistors Tdry are, currents iprg between the time points t4 and t6 are substantially the same. That can avoid charging inaccuracy caused by a difference between carrier drift rates of different driving transistors Tdrv.

For selection of the time point t4, refer to the following description.

Referring to FIG. 31, a simplified circuit diagram of the pixel circuit 100 is shown. Cload is capacitance equal to the display element Cbp and the display capacitor Cs2 connected in parallel. In an embodiment, the charging current Ids may be expressed as follows, where Vs is a source voltage of the driving transistor Tdrv, and K is a gain coefficient of the driving transistor Tdrv:

I_{ds}=K(V_{DT}−Vₛ−Vₜₕ)² Formula (1)

A charging speed Vs'(t) of the source voltage of the driving transistor Tdry is expressed as follows:

Vₛ'(t)=K[V_{dt}−Vₛ(t)]²/C_{load} Formula (2)

If assuming that Vs'(0) is 0 V, the following formula may be derived:

V(t)=KtV_{DT}²/(C_{load}+KtV_{DT}) Formula (3)

The following formula may be obtained by substituting the formula (3) into the formula (1):

I_{ds}(t)=K[C_{load}V_{DT}/(C_{load}+KtV_{DT})]² Formula (4)

According to the formula (4), when t=tc=Cload/(K*VDT), the driving transistors Tdry having different carrier drift rates all can obtain a same current iprg at the time point t4, where tc is a time difference between the time points t3 and t4.

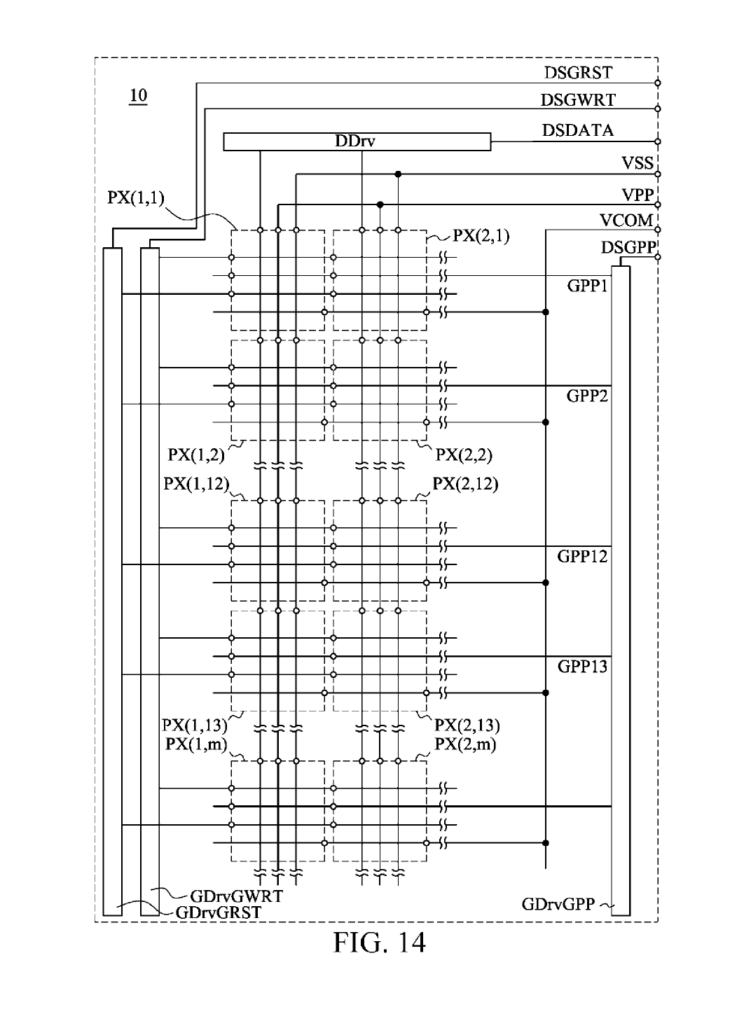

FIG. 14 is a schematic diagram of a display apparatus 10 according to an embodiment. In this embodiment, the display apparatus 10 includes multiple pixel circuits PX(1, 1), PX(2, 1), PX(1, 2), PX(2, 2), . . . , gate drive circuits GDrvGRST, GDrvGWRT, and GDrvGPP, and a data drive circuit DDrv. In this embodiment, the pixel circuits PX(1, 1), PX(2, 1), PX(1, 2), PX(2, 2), . . . all may have a structure of the pixel circuit 100 described above.

In this embodiment, the gate drive circuit GDrvGRST is configured to receive a signal DSGRST, and correspondingly output reset signals GRST1, GRST2, . . . , GRST12, GRST13, . . . to the pixel circuits PX(1, 1), PX(2, 1), PX(1, 2), PX(2, 2), . . . , as reset signals GRST of these pixel circuits PX(1, 1), PX(2, 1), PX(1, 2), PX(2, 2).

In this embodiment, the gate drive circuit GDrvGPP is configured to receive a signal DSGPP, and correspondingly output control signals GPP1, GPP2, . . . , GPP12, GPP13, . . . , to the pixel circuits PX(1, 1), PX(2, 1), PX(1, 2), PX(2, 2), . . . , as control signals GPP of these pixel circuits PX(1, 1), PX(2, 1), PX(1, 2), PX(2, 2).

In this embodiment, the gate drive circuit GDrvGWRT is configured to receive a signal DSGWRT, and correspondingly output writing signals GWRT1, GWRT2, . . . , GWRT12, GWRT13, . . . , to the pixel circuits PX(1, 1), PX(2, 1), PX(1, 2), PX(2, 2), . . . , as writing signals GWRT of these pixel circuits PX(1, 1), PX(2, 1), PX(1, 2), PX(2, 2).

In this embodiment, the source drive circuit DDry is configured to receive a signal DSDATA, and correspondingly output a preset voltage or data voltage to the pixel circuits PX(1, 1), PX(2, 1), PX(1, 2), PX(2, 2), . . . , as a preset voltage or data voltage VDT of these pixel circuits PX(1, 1), PX(2, 1), PX(1, 2), PX(2, 2).

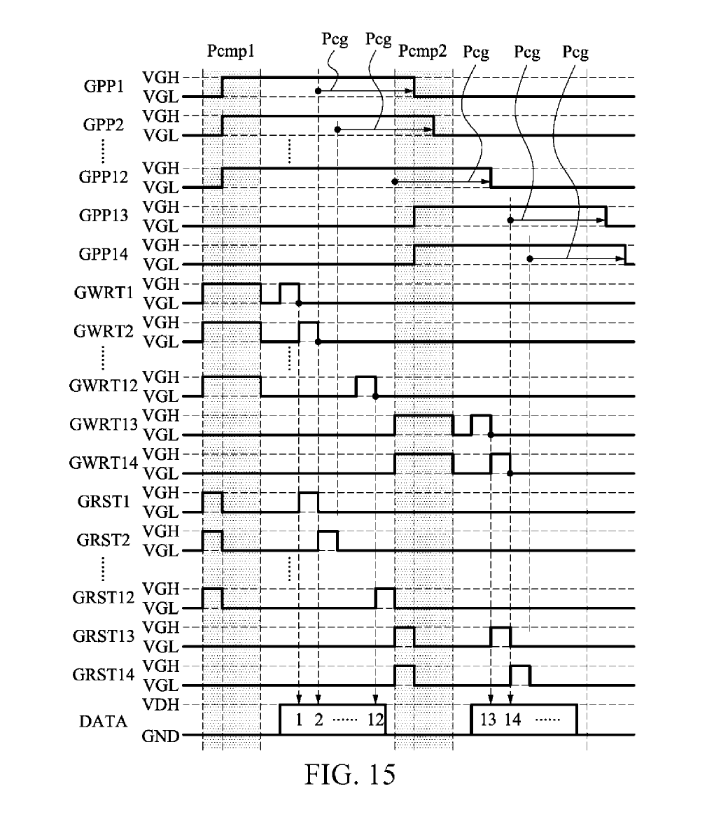

Referring to FIG. 14 and FIG. 15, in an embodiment, in a period Pcmp1, the display apparatus 10 may simultaneously make pixel circuits in some rows (for example, the 1^{st} to the 12^{th} rows) PX(1, 1), PX(2, 1), PX(1, 2), PX(2, 2), . . . , PX(1, 12), and PX(2, 12) enter a compensation stage, to perform the operations between the time points t0 and t2. In a period Pcmp2, the display apparatus 10 may simultaneously make pixel circuits in some other rows (for example, the 13^{th} to the 24^{th} rows) PX(13, 1), PX(14, 1), PX(13, 2), PX(14, 2), . . . , PX(1, 24), and PX(2, 24) enter the compensation stage, to perform the operations between the time points t0 and t2.

After the compensation stage, that is, after the period Pcmp1, the display apparatus 10 may perform the operations between the time points t3 and t6 on the pixel circuits PX(1, 1), PX(2, 1), PX(1, 2), PX(2, 2), . . . , in sequence by using reset signals GRST1, GRST2, . . . , and GRST12, control signals GPP1, GPP2, . . . , and GPP12, writing signals GWRT1, GWRT2, . . . , and GWRT12, and the preset voltage or data voltage VDT, to charge corresponding display capacitors Cs2 in a period Pcg (corresponding to the time points t5 and t6).

Moreover, after the period Pcmp2, the display apparatus 10 may perform the operations between the time points t3 and t6 on the corresponding pixel circuit in sequence by using reset signals GRST13, . . . , control signals GPP13, . . . , writing signals GWRT13, . . . , and the preset voltage or data voltage VDT, to charge corresponding display capacitors Cs2 in the period Pcg (corresponding to the time points t5 and t6).

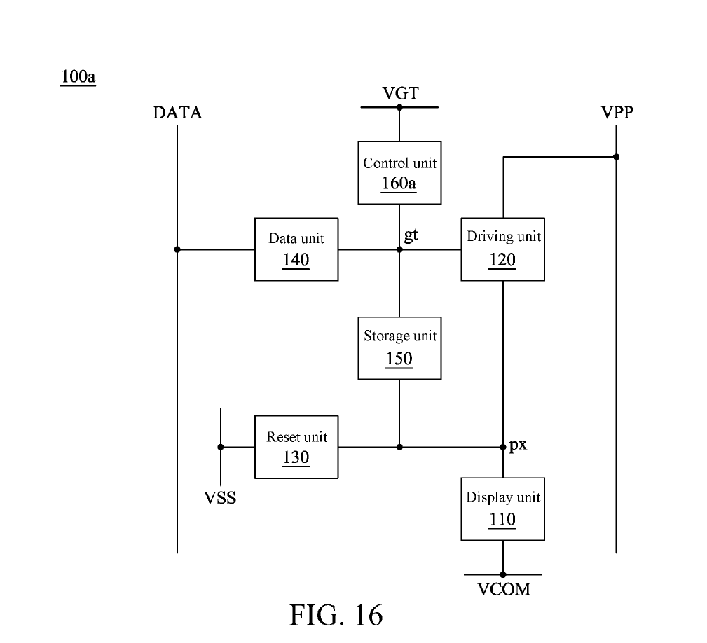

FIG. 16 is a schematic diagram of a pixel circuit 100a according to an embodiment. In this embodiment, the pixel circuit 100a includes: a display unit 110, a driving unit 120, a reset unit 130, a data unit 140, and a storage unit 150. The display unit 110, the driving unit 120, the reset unit 130, the data unit 140, and the storage unit 150 in the pixel circuit 100a have structures and operations approximately the same as those in the pixel circuit 100. Therefore, details are not described herein again.

In an embodiment, the pixel circuit 100a further includes a control unit 160a. The control unit 160a has one end electrically coupled to the node gt and another end receiving a control voltage VGT, and is configured to provide the control voltage VGT to the node gt.

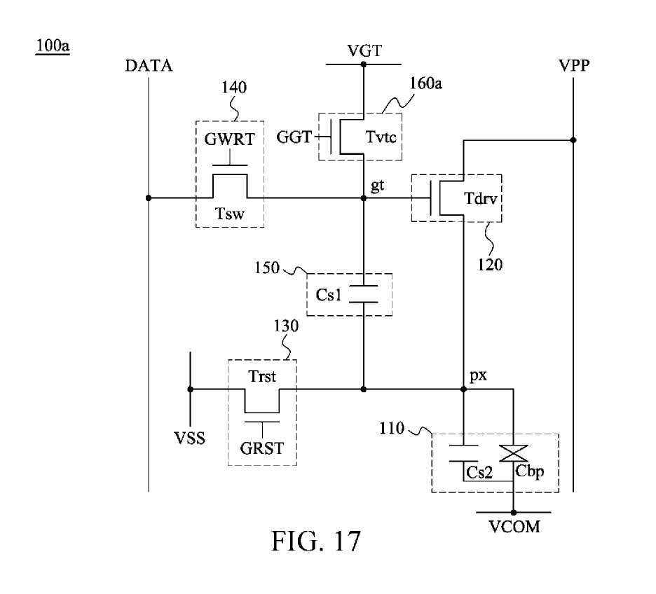

Referring to FIG. 17, in an embodiment, the display unit 110 includes a display element Cbp and a display capacitor Cs2. The driving unit 120 includes a driving transistor Tdrv. The reset unit 130 includes a reset transistor Trst. The data unit 140 includes a data transistor Tsw. The storage unit 150 includes a storage capacitor Cs1. The control unit 160a includes a control transistor Tvtc.

In this embodiment, connection relations between the display element Cbp, the display capacitor Cs2, the driving transistor Tdrv, the reset transistor Trst, the data transistor Tsw, and the storage capacitor Cs1 of the pixel circuit 100a are all the same as the connection relations in the pixel circuit 100. Therefore, details are not described herein again.

In this embodiment, the control transistor Tvtc has a first end, a second end, and a gate terminal. The first end of the control transistor Tvtc is electrically coupled to the gate terminal of the driving transistor Tdrv, and the second end of the control transistor Tvtc receives the control voltage VGT.

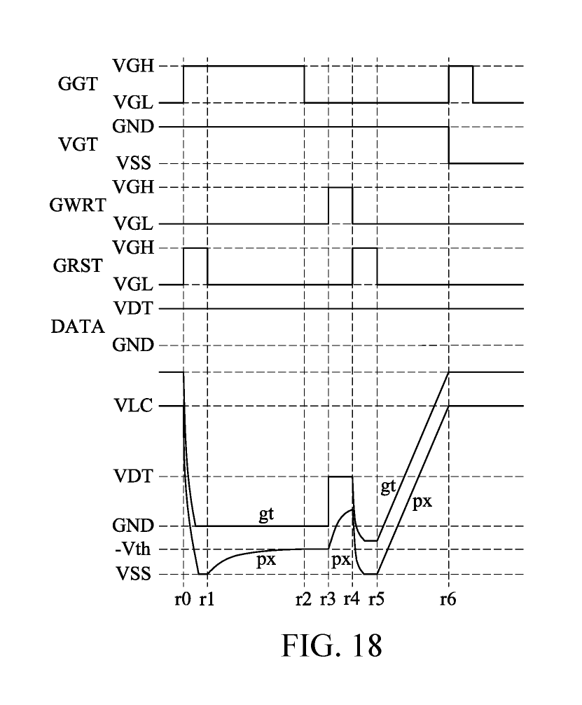

The following describes operations of the pixel circuit 100a in an embodiment with reference to FIG. 18 to FIG. 24.

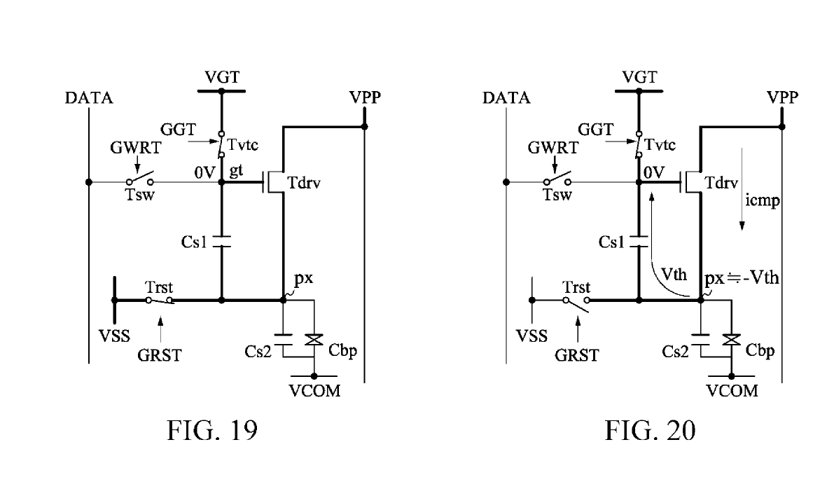

Referring to FIG. 18 and FIG. 19, between time points r0 and r1, the reset transistor Trst of the reset unit 130 is configured to be switched on in response to a reset signal GRST having a high voltage level VGH, to provide a reset voltage VSS to the node px. The data transistor Tsw of the data unit 140 is configured to be switched off in response to a writing signal GWRT having a low voltage level VGL. The control transistor Tvtc of the control unit 160a is switched on, in response to a control signal GGT having the high voltage level VGH, to provide a control voltage VGT having a voltage level GND (for example, 0 V) to the node gt. The driving transistor Tdry in the driving unit 120 is configured to be switched on, in response to the reset voltage VSS on the first end of the driving transistor Tdry and the control voltage VGT on the gate terminal of the driving transistor Tdrv, wherein a voltage difference between the control voltage VGT and the reset voltage VSS is greater than a threshold voltage Vth of the driving transistor Tdry (for example, a voltage on the node gt is less than −Vth).

Referring to FIG. 18 and FIG. 20, between time points r1 and r2, the reset transistor Trst of the reset unit 130 is configured to be switched off, in response to a reset signal GRST having the low voltage level VGL, to stop providing the reset voltage VSS to the node px. The data transistor Tsw of the data unit 140 is configured to be switched off in response to the writing signal GWRT having the low voltage level VGL. The control transistor Tvtc of the control unit 160a is configured to be switched on, in response to the control signal GGT having the high voltage level VGH, to continue to provide the control voltage VGT having the voltage level GND (for example, 0 V) to the node gt. The driving transistor Tdry in the driving unit 120 is configured to be switched on, in response to the control voltage VGT having the voltage level GND on the gate terminal of the driving transistor Tdry (that is, the node gt) and the voltage on the first end of the driving transistor Tdry (that is, the node px), to receive a compensation current icmp from the supply voltage source having the supply voltage VPP and hence to charge the node px until the voltage difference between the node gt and the node px is approximately equal to the threshold voltage Vth of the driving transistor Tdrv. At this time, the voltage on the node px is approximately equal to −Vth.

Next, between time points r2 and r3, the data transistor Tsw of the data unit 140 is configured to be switched off in response to the writing signal GWRT having the low voltage level VGL, the control transistor Tvtc of the control unit 160a is configured to be switched off in response to the control signal GGT having the low voltage level VGL, and the reset transistor Trst of the reset unit 130 is configured to be switched off in response to the reset signal GRST having the low voltage level VGL.

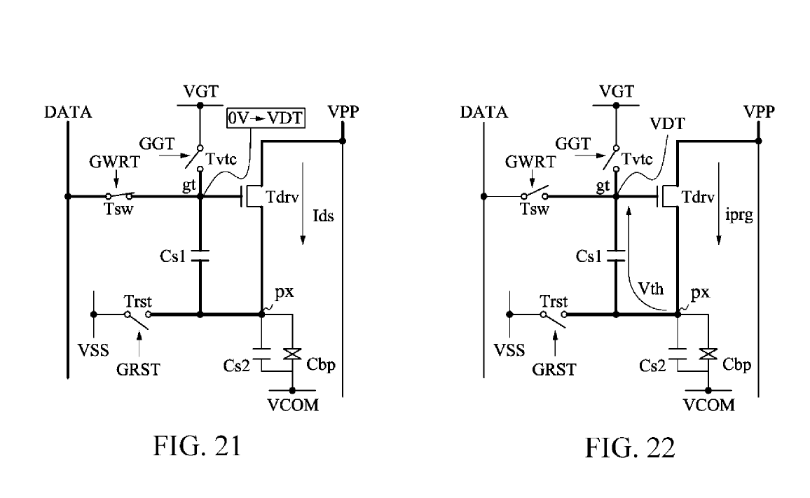

Referring to FIG. 18 and FIG. 21, between time points r3 and r4, the reset transistor Trst of the reset unit 130 is configured to be switched off in response to the reset signal GRST having the low voltage level VGL. The control transistor Tvtc of the control unit 160a is configured to be switched off, in response to the control signal GGT having the low voltage level VGL, to stop providing the control voltage VGT having the voltage level GND (for example, 0 V) to the node gt. The data transistor Tsw of the data unit 140 is configured to be switched on, in response to the writing signal GWRT having the high voltage level VGH, to provide a data voltage VDT to the node gt. The driving transistor Tdry in the driving unit 120 is configured to obtain a charging current Ids from the supply voltage source having the supply voltage VPP in response to the data voltage VDT in order to charge the node px, so that a voltage of the node px increases from −Vth. As the voltage of the node px increases, the voltage difference between the node px and node gt decreases, so that the charging current Ids also decreases.

Referring to FIG. 18 and FIG. 22, at the time point r4, the reset transistor Trst of the reset unit 130 is configured to be switched off in response to the reset signal GRST having the low voltage level VGL. The control transistor Tvtc of the control unit 160a is configured to be switched off in response to the control signal GGT having the low voltage level VGL. The data transistor Tsw of the data unit 140 is configured to be switched off, in response to the writing signal GWRT having the low voltage level VGL, to stop providing the data voltage VDT to the node gt. At this time, a voltage difference Vprg exists between the node px and the node gt. The driving transistor Tdry in the driving unit 120 obtains a fixed current iprg from the supply voltage source having the supply voltage VPP in response to the voltage difference Vprg between the node px and the node gt, to charge the node px.

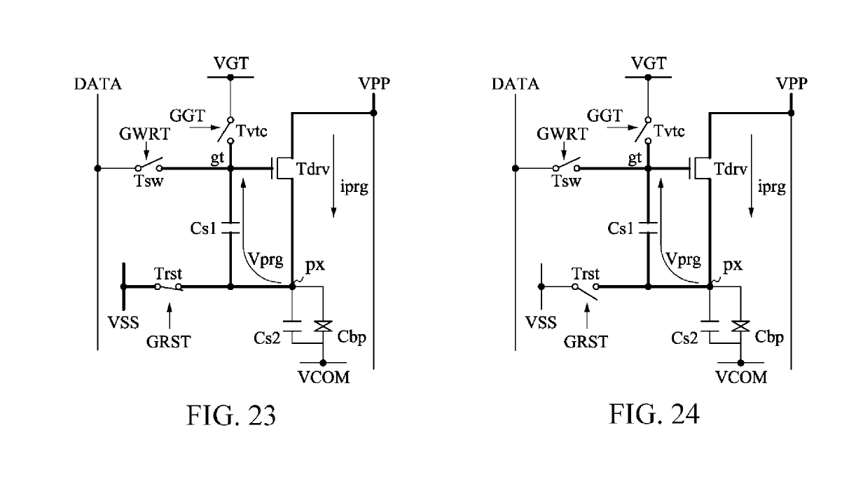

Referring to FIG. 18 and FIG. 23, between time points r4 and r5, the control transistor Tvtc of the control unit 160a is configured to be switched off in response to the control signal GGT having the low voltage level VGL. The data transistor Tsw of the data unit 140 is configured to be switched off in response to the writing signal GWRT having the low voltage level VGL. The reset transistor Trst of the reset unit 130 is configured to be switched on, in response to the writing signal GWRT having the high voltage level VGH, to provide the reset voltage VSS to the node px, to simultaneously decrease voltages of the node px and the node gt. At this time, the voltage difference Vprg exists between the node px and the node gt, and the driving transistor Tdry in the driving unit 120 obtains the fixed current iprg from the supply voltage source having the supply voltage VPP in response to the voltage difference Vprg between the node px and the node gt.

Referring to FIG. 18 and FIG. 24, between time points r5 and r6, the control transistor Tvtc of the control unit 160a is configured to be switched off in response to the control signal GGT having the low voltage level VGL. The data transistor Tsw of the data unit 140 is configured to be switched off in response to the writing signal GWRT having the low voltage level VGL. The reset transistor Trst of the reset unit 130 is configured to be switched off in response to the writing signal GWRT having the low voltage level VGL, to stop providing the reset voltage VSS to the node px. At this time, the voltage difference Vprg exists between the node px and the node gt, and the driving transistor Tdry in the driving unit 120 obtains the fixed current iprg from the supply voltage source having the supply voltage VPP in response to the voltage difference Vprg between the node px and the node gt, to charge the node px, to simultaneously increase the voltages of the node px and the node gt.

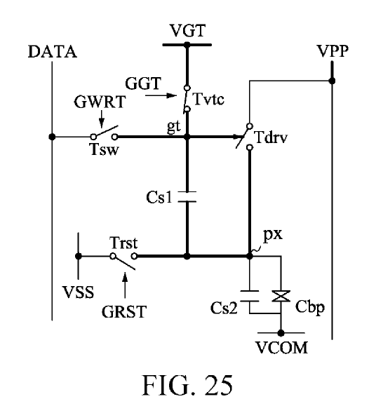

Referring to FIG. 18 and FIG. 25, after the time point r6, the control transistor Tvtc of the control unit 160a is configured to be switched on, in response to the control signal GGT having the high voltage level VGH, to provide the control voltage VGT having a voltage level the same as that of the reset voltage VSS to the node gt. The data transistor Tsw of the data unit 140 is configured to be switched off in response to the writing signal GWRT having the low voltage level VGL. The reset transistor Trst of the reset unit 130 is configured to be switched off in response to the reset signal GRST having the low voltage level VGL. At this time, the driving transistor Tdry in the driving unit 120 switches off the control voltage VGT having a voltage level the same as that of the reset voltage VSS, to stop charging the node px. A voltage applied on two ends of the display capacitor Cs2 is kept at a fixed level, to charge the display element Cbp.

By means of the foregoing settings, the pixel circuit 100a can be implemented by using four transistors, and can reduce the influence on an aperture ratio of a display apparatus. In addition, the foregoing operations can avoid using an excessively high data voltage VDT and increasing operation complexity.

In addition, as compared with the foregoing embodiment, in this embodiment, because the preset voltage having the voltage level GND in FIG. 3 to FIG. 10 is not transmitted by using the data line DATA, a compensation period between the time points r0 and r2 is lengthened, so that the threshold voltage Vth stored in the storage capacitor Cs1 is more accurate.

Further, because the gate of the driving transistor Tdry has a gate bias of a negative voltage after the time point r6, aging of the driving transistor Tdry can be slowed down.

It is noted that, in the foregoing operations, the time point r4 may be controlled, to compensate the current iprg, so that driving transistors Tdry having different carrier drift rates all can obtain a same current iprg at the time point r4. For specific details, refer to the foregoing embodiment, which are not described herein again.

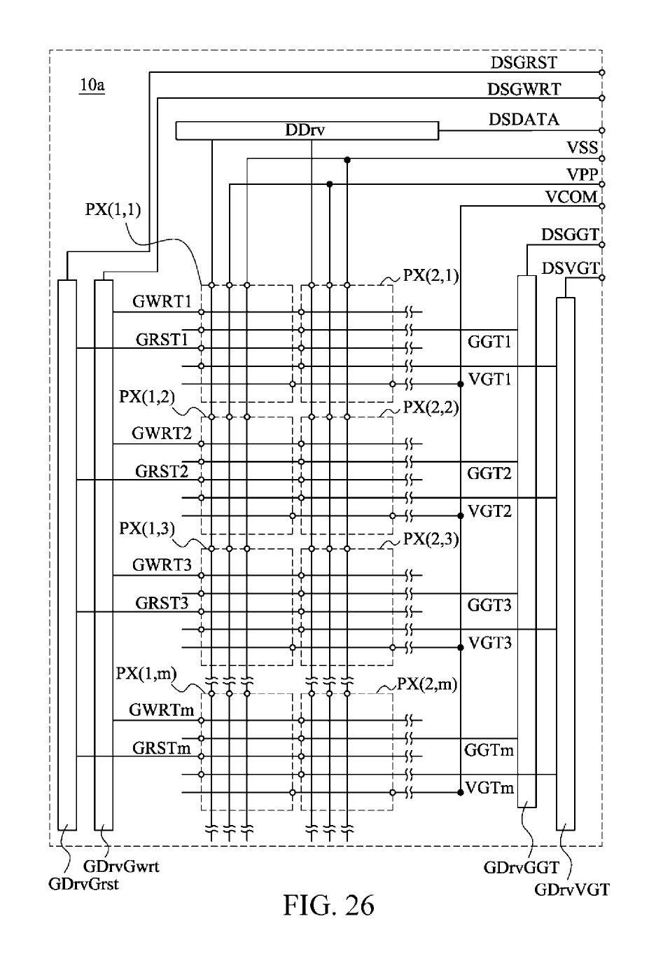

FIG. 26 is a schematic diagram of a display apparatus 10a according to an embodiment. In this embodiment, the display apparatus 10a includes multiple pixel circuits PX(1, 1), PX(2, 1), PX(1, 2), PX(2, 2), PX(1, 3), PX(2, 3), . . . , gate drive circuits GDrvGRST, GDrvGWRT, GDrvGGT, and GDrvVGT and a data drive circuit DDrv. In this embodiment, the pixel circuits PX(1, 1), PX(2, 1), PX(1, 2), PX(2, 2), PX(1, 3), PX(2, 3), . . . all may have a structure of the pixel circuit 100a described above.

In this embodiment, operations of the gate drive circuits GDrvGRST and GDrvGWRT and the data drive circuit DDry of the display apparatus 10a are approximately similar to those in the display apparatus 10. Therefore, details are not described herein again.

In this embodiment, the gate drive circuit GDrvGGT is configured to receive a signal DSGGT, and correspondingly output control signals GGT1, GGT2, GGT3, . . . to the pixel circuits PX(1, 1), PX(2, 1), PX(1, 2), PX(2, 2), PX(1, 3), PX(2, 3), . . . , as control signals GGT of these pixel circuits PX(1, 1), PX(2, 1), PX(1, 2), PX(2, 2), PX(1, 3), PX(2, 3).

In this embodiment, the gate drive circuit GDrvVGT is configured to receive a signal DSVGT, and correspondingly output control voltages VGT1, VGT2, VGT3, . . . to the pixel circuits PX(1, 1), PX(2, 1), PX(1, 2), PX(2, 2), PX(1, 3), PX(2, 3), . . . , as control voltages VGT of these pixel circuits PX(1, 1), PX(2, 1), PX(1, 2), PX(2, 2), PX(1, 3), PX(2, 3).

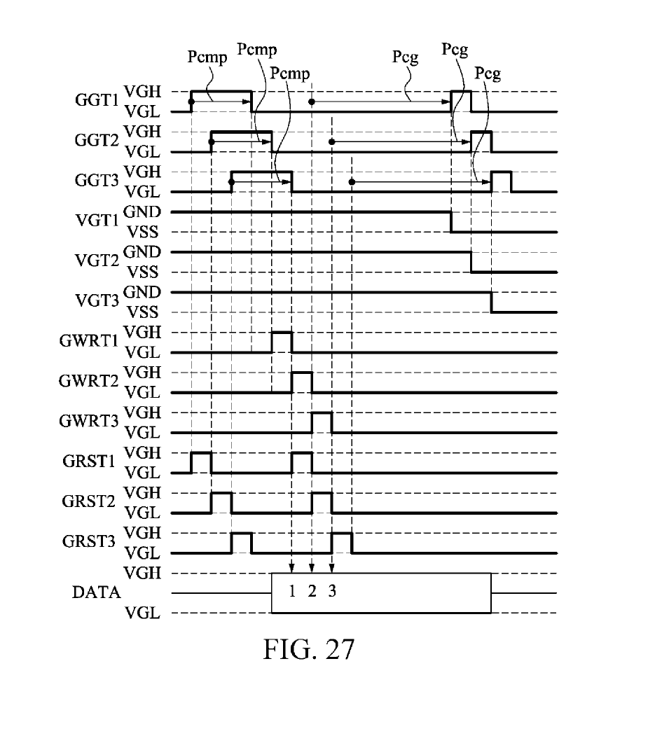

Referring to FIG. 26 and FIG. 27, in an embodiment, the display apparatus 10a may perform the operations between the time points r0 and r6 on the pixel circuits PX(1, 1), PX(2, 1), PX(1, 2), PX(2, 2), PX(1, 3), PX(2, 3), . . . in sequence by using reset signals GRST1, GRST2, GRST3, . . . , control signals GGT1, GGT2, GGT3, . . . , writing signals GWRT1, GWRT2, GWRT12, GWRT13, . . . , control voltages VGT1, VGT2, VGT3, . . . , and a data voltage, to compensate the pixel circuits PX(1, 1), PX(2, 1), PX(1, 2), PX(2, 2), PX(1, 3), and PX(2, 3) (for example, the operations between the time points r0 and r2) in a period Pcmp (that is, the time points r0 and r2), and charge display capacitors Cs2 of the pixel circuits PX(1, 1), PX(2, 1), PX(1, 2), PX(2, 2), PX(1, 3), and PX(2, 3) (for example, the operations between the time points r5 and r6) in a period Pcg.

It should be noted that, in the display apparatus 10a, because the data line DATA does not need to transmit the preset voltage having the voltage level GND in FIG. 3 to FIG. 10, the data voltage VDT can be continuously provided to the pixel circuits PX(1, 1), PX(2, 1), PX(1, 2), PX(2, 2), PX(1, 3), and PX(2, 3).

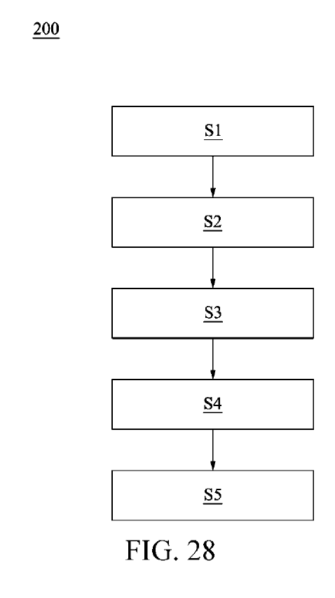

Other details of the present disclosure are provided below by using an operating method 200 in FIG. 28, but the present disclosure is not limited to the following embodiment.

It should be noted that, the operating method 200 may be applied to a pixel circuit having a structure the same as or similar to that shown in FIG. 2. For ease of description, the following describes the operating method 200 according to an embodiment of the present disclosure by using the pixel circuit 100 in FIG. 2 as an example, but the present disclosure is not limited thereto.

In addition, it should be noted that, for steps of the operating method 200 mentioned in this implementation manner, unless an order is specially described, the order of the steps may be adjusted according to an actual requirement, or the steps may be even simultaneously or partially simultaneously performed.

Further, in different embodiments, these steps may appropriately have a step added, replaced, and/or omitted.

In this embodiment, the operating method 200 includes the following steps.

Step S1. The pixel circuit 100 provides a reset voltage VSS to the first end of the driving transistor Tdrv, and provides a preset voltage having a voltage level GND (for example, 0 V) to the gate terminal of the driving transistor Tdrv, so that the driving transistor Tdry is switched on in response to the preset voltage and the reset voltage VSS.

Step S2. The pixel circuit 100 conducts the supply voltage source having a supply voltage VPP and the second end of the driving transistor Tdrv, and stops providing the reset voltage VSS to the first end of the driving transistor Tdrv, so that the driving transistor Tdry receives a compensation current icmp, to charge the display unit 110, until a cross voltage on two ends of the storage capacitor Cs1 is a threshold voltage Vth of the driving transistor Tdrv.

Step S3. The pixel circuit 100 provides a data voltage VDT to the gate terminal of the driving transistor Tdrv, and conducts the supply voltage source having the supply voltage VPP and the second end of the driving transistor Tdrv, so that the driving transistor Tdry receives a driving current Ids in response to the data voltage VDT, to charge the display unit 110, until the cross voltage on the two ends of the storage capacitor Cs1 is set voltage Vprg.

Step S4. The pixel circuit 100 stops providing the data voltage VDT to the gate terminal of the driving transistor Tdrv, and provides the reset voltage VSS to the first end of the driving transistor Tdrv.

Step S5. The pixel circuit 100 stops providing the data voltage VDT to the gate terminal of the driving transistor Tdrv, stops providing the reset voltage VSS to the first end of the driving transistor Tdrv, and conducts the supply voltage source having the supply voltage VPP and the second end of the driving transistor Tdrv, so that the driving transistor Tdry receives a charging current iprg in response to the set voltage Vprg, to charge the display unit 110.

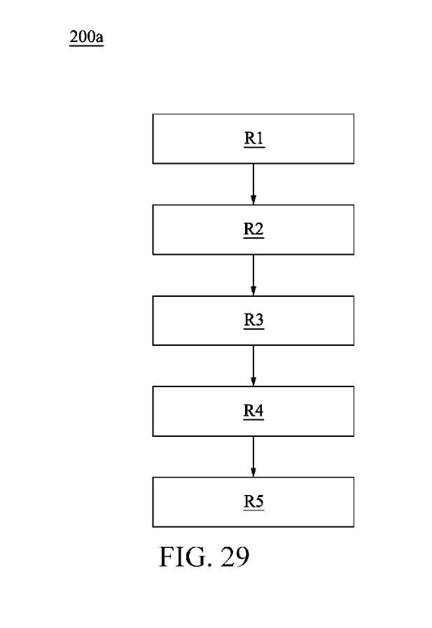

Other details are provided below by using an operating method 200a in FIG. 29, but the present disclosure is not limited to the following embodiment.

It should be noted that, the operating method 200a may be applied to a pixel circuit having a structure the same as or similar to that shown in FIG. 17. For ease of description, the following describes the operating method 200a according to an embodiment of the present disclosure by using the pixel circuit 100a in FIG. 17 as an example, but the present disclosure is not limited thereto.

In addition, it should be noted that, for steps of the operating method 200a mentioned in this implementation manner, unless an order is specially described, the order of the steps may be adjusted according to an actual requirement, or the steps may be even simultaneously or partially simultaneously performed.

Further, in different embodiments, these steps may appropriately have a step added, replaced, and/or omitted.

In this embodiment, the operating method 200a includes the following steps. Step R1. The pixel circuit 100a provides a control voltage VGT to the gate terminal of the driving transistor Tdry and provides a reset voltage VSS to the first end of the driving transistor Tdrv, so that the driving transistor Tdry is switched on in response to the control voltage VGT and the reset voltage VSS.

Step R2. The pixel circuit 100a provides the control voltage VGT to the gate terminal of the driving transistor Tdry and stops providing the reset voltage VSS to the first end of the driving transistor Tdrv, so that the driving transistor Tdry receives a compensation current icmp, to charge the display unit 110, until a cross voltage on two ends of the storage capacitor Cs1 is a threshold voltage Vth of the driving transistor Tdrv.

Step R3. The pixel circuit 100a stops providing the control voltage VGT to the gate terminal of the driving transistor Tdry and provides a data voltage VDT to the gate terminal of the driving transistor Tdrv, so that the driving transistor Tdry receives a driving current Ids, in response to the data voltage VDT, to charge the display unit 110, until the cross voltage on the two ends of the storage capacitor Cs1 is set voltage Vprg.

Step R4. The pixel circuit 100a stops providing the control voltage VGT to the gate terminal of the driving transistor Tdrv, stops providing the data voltage VDT to the gate terminal of the driving transistor Tdrv, and provides the reset voltage VSS to the first end of the driving transistor Tdrv.

Step R5. The pixel circuit 100 stops providing the control voltage VGT to the gate terminal of the driving transistor Tdrv, stops providing the data voltage VDT to the gate terminal of the driving transistor Tdrv, and stops providing the reset voltage VSS to the first end of the driving transistor Tdrv, so that the driving transistor Tdry receives a charging current iprg in response to the set voltage Vprg, to charge the display unit 110.

Although the present disclosure is disclosed by using the foregoing embodiments, these embodiments are not intended to limit the present disclosure. Various changes and modifications made without departing from the spirit and scope of the present disclosure shall fall within the protection scope of the present disclosure. The protection scope of the present disclosure is subject to the appended claims.

What is claimed is:

1. A pixel circuit, comprising:
a display unit, electrically coupled to a first supply voltage source, wherein the display unit comprises a display element;
a driving transistor, having a first end, a second end, and a gate terminal, wherein the first end of the driving transistor is electrically coupled to the display unit, and the second end of the driving transistor is electrically coupled to a second supply voltage source;
a reset transistor, having one end electrically coupled to the first end of the driving transistor and another end electrically coupled to a reset voltage source;
a data transistor, having one end electrically coupled to the gate terminal of the driving transistor and another end electrically coupled to a data voltage source; and
a storage capacitor, having one end electrically coupled to the first end of the driving transistor and another end electrically coupled to the gate terminal of the driving transistor.

2. The pixel circuit according to claim 1, further comprising:
a control transistor, having one end electrically coupled to the second end of the driving transistor and another end electrically coupled to the second supply voltage source.

3. The pixel circuit according to claim 1, further comprising:
a control transistor, having one end electrically coupled to the gate terminal of the driving transistor and another end electrically coupled to a control voltage source.

4. A pixel circuit, comprising:
a display unit, electrically coupled to a first supply voltage source, wherein the display unit comprises a display element;
a driving unit, having one end electrically coupled to the display unit and another end electrically coupled to a second supply voltage source, and configured to charge the display unit;
a reset unit, electrically coupled to the driving unit and the display unit, and configured to provide a reset voltage to an operating node between the driving unit and the display unit;
a data unit, electrically coupled to the driving unit, and configured to provide a data voltage to the driving unit; and
a storage unit, having one end electrically coupled to the data unit and another end electrically coupled to the display unit, and configured to store a voltage difference between the operating node and a data node between the data unit and the driving unit.

5. The pixel circuit according to claim 4, further comprising:
a control unit, having one end electrically coupled to the driving unit and another end electrically coupled to the second supply voltage source, and configured to switch on or switch off a conductive path between the driving unit and the second supply voltage source.

6. The pixel circuit according to claim 5, wherein at a first stage, the reset unit is configured to provide the reset voltage to the operating node, the data unit is configured to provide a preset voltage to the data node, and a driving transistor in the driving unit is configured to be switched on in response to the reset voltage and the preset voltage.

7. The pixel circuit according to claim 5, wherein at a second stage, the reset unit is configured to stop providing the reset voltage to the operating node, the control unit is configured to conduct the second supply voltage source and the driving unit, and the driving unit is configured to receive a compensation current from the second supply voltage source in order to charge the operating node.

8. The pixel circuit according to claim 5, wherein at a third stage, the data unit is configured to provide the data voltage to the operating node, the control unit is configured to conduct the second supply voltage source and the driving unit, and the driving unit is configured to receive a driving current from the second supply voltage source in response to the data voltage, to charge the operating node.

9. The pixel circuit according to claim 8, wherein at a fourth stage, the reset unit is configured to provide the reset voltage to the operating node, the data unit is configured to stop providing the data voltage to the data node, the control unit is configured to conduct the second supply voltage source and the driving unit, and the driving unit is configured to charge the display unit.

10. The pixel circuit according to claim 4, wherein at a reset stage, the data unit is configured to stop providing the data voltage to the data node, and the reset unit is configured to provide the reset voltage to the operating node.

11. The pixel circuit according to claim 4, further comprising:
a control unit, electrically coupled to the data node, and configured to provide a control voltage to the data node.

12. The pixel circuit according to claim 11, wherein at a first stage, the reset unit is configured to provide the reset voltage to the operating node, the control unit is configured to provide the control voltage to the data node, and a driving transistor in the driving unit is configured to be switched on in response to the control voltage and the reset voltage.

13. The pixel circuit according to claim 11, wherein at a second stage, the reset unit is configured to stop providing the reset voltage to the operating node, the control unit is configured to provide the control voltage to the operating node, and the driving unit is configured to receive a compensation current from the second supply voltage source in order to charge the operating node.

14. The pixel circuit according to claim 11, wherein at a third stage, the control unit is configured to stop providing the control voltage to the operating node, the data unit is configured to provide the data voltage to the data node, and the driving unit is configured to receive a driving current from the second supply voltage source in response to the data voltage, to charge the operating node.

15. The pixel circuit according to claim 14, wherein at a fourth stage, the control unit is configured to stop providing the control voltage to the data node, the reset unit is configured to stop providing the reset voltage to the operating node, the data unit is configured to stop providing the data voltage to the data node, and the driving unit is configured to charge the display unit.

16. The pixel circuit according to claim 12, wherein at a maintenance stage, the control unit is configured to provide a cut-off voltage to the data node in order to switch off the driving transistor in the driving unit.

17. An operating method of a pixel circuit, wherein the pixel circuit comprises a display unit, a driving transistor, and a storage capacitor, the display unit is electrically coupled to a first end of the driving transistor, one end of the storage capacitor is electrically coupled to the first end of the driving transistor, another end of the storage capacitor is electrically coupled to a gate terminal of the driving transistor, and the operating method comprises:
providing a reset voltage to the first end of the driving transistor, and providing a preset voltage to the gate terminal of the driving transistor;
conducting a second supply voltage source and a second end of the driving transistor, and stopping providing the reset voltage to the first end of the driving transistor, so that the driving transistor receives a compensation current charging the display unit, and a voltage difference between two ends of the storage capacitor gradually approaches a threshold voltage of the driving transistor;
providing a data voltage to the gate terminal of the driving transistor, and conducting the second supply voltage source and the second end of the driving transistor, so that the driving transistor receives a driving current in response to the data voltage in order to charge the display unit, until the voltage difference between the two ends of the storage capacitor is a set voltage;
stopping providing the data voltage to the gate terminal of the driving transistor, and providing the reset voltage to the first end of the driving transistor; and
stopping providing the reset voltage to the first end of the driving transistor, and conducting the second supply voltage source and the second end of the driving transistor, so that the driving transistor receives a charging current in response to the set voltage to charge the display unit.

18. The operating method according to claim 17, further comprising:
cutting off a conductive path between the second supply voltage source and the second end of the driving transistor, so that the driving transistor stops receiving the charging current in response to the set voltage.

19. An operating method of a pixel circuit, wherein the pixel circuit comprises a display unit, a driving transistor, and a storage capacitor, the display unit is electrically coupled to a first end of the driving transistor, one end of the storage capacitor is electrically coupled to the first end of the driving transistor, another end of the storage capacitor is electrically coupled to a gate terminal of the driving transistor, and the operating method comprises:
providing a control voltage to the gate terminal of the driving transistor, and providing a reset voltage to the first end of the driving transistor;
providing the control voltage to the gate terminal of the driving transistor, and stopping providing the reset voltage to the first end of the driving transistor, so that the driving transistor receives a compensation current in order to charge the display unit, and a voltage difference between two ends of the storage capacitor gradually approaches a threshold voltage of the driving transistor;
stopping providing the control voltage to the gate terminal of the driving transistor, and providing a data voltage to the gate terminal of the driving transistor, so that the driving transistor receives a driving current, in response to the data voltage, to charge the display unit, until the voltage difference between the two ends of the storage capacitor is a set voltage;
stopping providing the data voltage to the gate terminal of the driving transistor, and providing the reset voltage to the first end of the driving transistor; and
stopping providing the control voltage to the gate terminal of the driving transistor, so that the driving transistor receives a charging current, in response to the set voltage, to charge the display unit.

20. The operating method according to claim 19, further comprising:
providing a cut-off voltage to the data node to switch off the driving transistor.
